(19) United States
(12) Patent Application Publication
(10) Pub. No.: US 2017/0210351 A1
(43) Pub. Date: Jul. 27, 2017

(54) EXTERIOR VIEW CAMERA WASHER SYSTEM WITH ELASTIC, CHANGEABLE, SELF-WETTING AND CLEANING MECHANISM

(71) Applicant: Ford Global Technologies, LLC, Dearborn, MI (US)

(72) Inventors: Mahmoud Yousef Ghannam, Canton, MI (US); David James Tippy, Ann Arbor, MI (US); Steven Yellin Schondorf, Dearborn, MI (US); Ahmad Maarouf, Canton, MI (US)

(21) Appl. No.: 15/003,869

(22) Filed: Jan. 22, 2016

(51) Int. Cl. B60S 1/56; B60S 1/50; B60R 11/04

(52) U.S. Cl. CPC B60S 1/566; B60R 11/04; B60S 1/50

(57) ABSTRACT

A vehicle camera washing system is disclosed. In one embodiment, the system includes a housing configured for supporting a vehicle camera, a housing cover having an aperture for a lens of the vehicle camera, the housing cover removably positioned on a face of the housing, a circular groove positioned in the face of the housing, a first wiper anchor fixedly positioned in the groove, a second wiper anchor movably positioned in the groove, and elastic wiper extending from the first wiper anchor to the second wiper anchor.

### BACKGROUND

This application relates generally to the field of camera cleaning systems, and more particularly to systems and methods for cleaning external cameras mounted on a vehicle.

A Reversing Video Device (RVD) may be mounted on vehicles, such as an automobile, to assist a driver of the vehicle to avoid objects and people in the path of the vehicle when the vehicle is driven, such as in reverse. RVD systems may include a camera, such as a Rear View Camera (RVC), mounted on the vehicle to capture video of the scene surrounding the vehicle, and a video display unit mounted in the driver's line of sight to allow the driver to view the display when driving the vehicle.

Some mounting locations of a vehicle's camera, such as a rear view camera, may cause the camera's lens to collect dust, dirt, and debris, which may obscure the field of view of the camera. There exists a need, therefore, to provide a washing system that removes such dust, dirt, and debris to maintain the functionality of the camera or other externally facing device, such as a radar unit, while being easily accessible and maintainable by an owner of the vehicle.

Some automobiles may have a rear window washing system, but adapting such systems to address the problem of a dirty rear view camera would require higher pressure fluid pumps to compensate for the additional pressure drop in the washer fluid line to reach the rear view camera.

### SUMMARY

A vehicle camera washing system is disclosed. In one embodiment, the system includes a housing configured for supporting a vehicle camera, a housing cover having an aperture for a lens of the vehicle camera, the housing cover removably positioned on a face of the housing, a circular groove positioned in the face of the housing, a first wiper anchor fixedly positioned in the groove, a second wiper anchor movably positioned in the groove, and an elastic wiper extending from the first wiper anchor to the second wiper anchor.

The system may include a motor connected to the second wiper anchor. The motor may be configured to move the second wiper anchor along the groove from a first position to a second position. Movement of the second wiper anchor to the second position may stretch the wiping elements across the camera lens. The first position may be at a 3 o'clock position on the face of the housing, and the second position may be at a 6 o'clock position on the face of the housing.

The motor may move the second wiper anchor in a counter-clockwise direction in the groove until the second position is reached, and then may move the second wiper anchor in a clockwise direction in the groove until the first position is reached, the wiper thereby being swept across the lens of the camera. The system may also include a fluid delivery system including a valve positioned on a periphery of the housing. The valve may be connected to a fluid tank by a conduit configured to convey a fluid from the fluid tank to the valve. The valve may be actuated to release the fluid onto the lens of the camera by movement of the second wiper anchor past the valve. The valve may be radially positioned at a 2 o'clock position on the housing and a second valve may be radially positioned at a 10 o'clock position on the housing. The wiper may include a plurality of wiping elements configured to sweep across the lens of the camera.

Another embodiment of a vehicle camera washing system for a vehicle camera lens cover is disclosed. In this embodiment, the system includes a washer housing, a circular slot positioned in a face of the housing, a first wiper anchor fixedly positioned on the face of the housing, a second wiper anchor movably positioned in the slot, and a variable extension wiper extending from the first wiper anchor to the second wiper anchor, the wiper comprising a wiping element configured to sweep across the vehicle camera lens cover.

The system may include a reciprocating motor connected to the second wiper anchor. The motor may be configured to move the second wiper anchor along the slot from a first position to a second position. Movement of the second wiper anchor to the second position may variably extend the wiping element across the vehicle camera lens cover.

The reciprocating motor may move the second wiper anchor in a counter-clockwise direction in the slot until the second position is reached, and then may move the second wiper anchor in a clockwise direction in the slot until the first position is reached, the wiper thereby being swept across the camera lens cover. The system may include a rod pivotally connected on one end to an output shaft of the reciprocating motor and pivotally connected on an opposite end to the second wiper anchor.

The first wiper anchor may include a valve connected to a fluid tank by a conduit configured to convey a fluid from the fluid tank to the valve. The valve may be configured to dispense the fluid onto the vehicle camera lens cover. The wiper may include at least one orifice positioned between the first wiper anchor and the second wiper anchor along the wiper. The at least one orifice may be connected to the valve for dispensing the fluid onto the vehicle camera lens cover.

Another embodiment of a vehicle camera washing system for a vehicle camera lens cover is disclosed. In this embodiment, the system includes a driver gear, a first gear positioned adjacent to and driven by the driver gear, the first gear comprising a ring positioned around the lens cover, a wiper mount positioned adjacent to the first gear, and an elastic wiper pivotally attached to the wiper mount on one end and pivotally attached to a perimeter face of the first gear on an opposite end, the wiper configured to elastically extend and sweep across the lens cover upon rotational movement of the first gear by the driver gear.

The system may include a motor connected to the driver gear. The motor may be configured to rotate the driver gear. The opposite end of the wiper may follow rotation of the first gear as the driver gear rotates in either a clockwise or counter-clockwise direction. The system may also include a controller connected to a computer processor. The controller may be coupled to the motor and configured to command rotation of the driver gear through a plurality of rotational angles and rotation cycles.

### BRIEF DESCRIPTION OF THE DRAWINGS

FIG. 1A illustrates a top view of a vehicle of the instant disclosure.

FIG. 1B illustrates a rear view of the vehicle shown in FIG. 1A.

FIG. 2 illustrates a block diagram of exemplary components of the vehicle shown in FIG. 1A.

FIG. 3 illustrates a block diagram of an exemplary computing device operatively connected to the vehicle shown in FIG. 1A.

FIG. 4A illustrates a perspective view of an embodiment of a camera washing system of the instant disclosure with the housing cover removed and with the wiper shown in a first position.

FIG. 4B illustrates a perspective view of the camera washing system shown in FIG. 4A with the housing cover installed.

FIG. 4C illustrates a perspective view of another aspect of the camera washing system shown in FIG. 4A with the housing cover removed and with the wiper shown in a second one of a plurality of positions.

FIG. 4D illustrates a schematic view of another aspect of the camera washing system shown in FIG. 4A showing the wiper in one of a plurality of positions.

FIG. 4E illustrates a schematic view of another aspect of the camera washing system shown in FIG. 4A showing the wiper in a second one of a plurality of positions.

FIG. 4F illustrates a schematic view of another aspect of the camera washing system shown in FIG. 4A showing the wiper in a third one of a plurality of positions.

FIG. 5A illustrates a perspective view of another embodiment of a camera washing system of the instant disclosure with the housing cover removed.

FIG. 5B illustrates a perspective view of another aspect of the camera washing system shown in FIG. 5A with the wiper shown in another one of a plurality of positions.

FIG. 5C illustrates a partial detail perspective view of the camera washing system shown in FIG. 5B.

FIG. 5D illustrates a perspective view of another aspect of the camera washing system shown in FIG. 5A.

FIG. 6A illustrates an exploded perspective view of another embodiment of a camera washing system of the instant disclosure.

FIG. 6B illustrates a perspective view of the camera washing system shown in FIG. 6A.

FIG. 6C illustrates a partial detail perspective view of the camera washing system shown in FIG. 6A showing the wiper in a first one of a plurality of positions.

FIG. 6D illustrates a partial detail perspective view of the camera washing system shown in FIG. 6A showing the wiper in a second one of a plurality of positions.

FIG. 6E illustrates a partial detail perspective view of the camera washing system shown in FIG. 6A showing the wiper in a third one of a plurality of positions.

FIG. 6F illustrates a partial detail perspective view of the camera washing system shown in FIG. 6A showing the wiper in a fourth one of a plurality of positions.

FIG. 6G illustrates a partial detail perspective view of the camera washing system shown in FIG. 6A showing the wiper in a fifth one of a plurality of positions.

### DETAILED DESCRIPTION

Although the figures and the instant disclosure describe one or more embodiments of a camera washing system, one of ordinary skill in the art would appreciate that the teachings of the instant disclosure would not be limited to these embodiments.

Turning now to the drawings wherein like reference numerals refer to like elements, there are shown exemplary embodiments and methods of a washing system for a vehicle camera or other device that may collect dust, dirt, and/or debris for which cleaning may be useful.

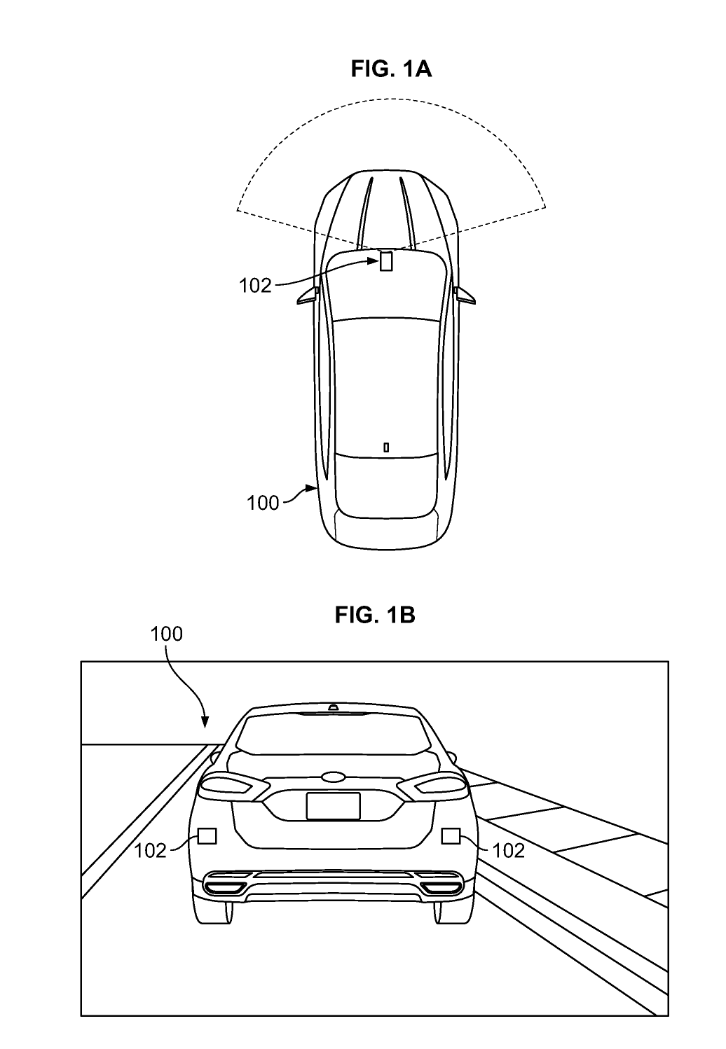

FIGS. 1A-1B show vehicle 100 in accordance with one embodiment of the instant disclosure. In this embodiment, vehicle 100 is an automobile, though in other embodiments vehicle 100 may be any suitable vehicle (such as a truck, a watercraft, or an aircraft). Vehicle 100 may be a gasoline powered vehicle, a hybrid vehicle, an electric vehicle, a fuel cell vehicle, or any other type of suitable vehicle. Vehicle 100 may include standard features, such as a dashboard, adjustable seats, one or more batteries, an engine or motor, a transmission, an HVAC system including a compressor and electronic expansion valve, a windshield and/or one or more windows, doors, a rear view mirror, a right side view mirror, a left side view mirror, seatbelts, airbags, wheels, and tires.

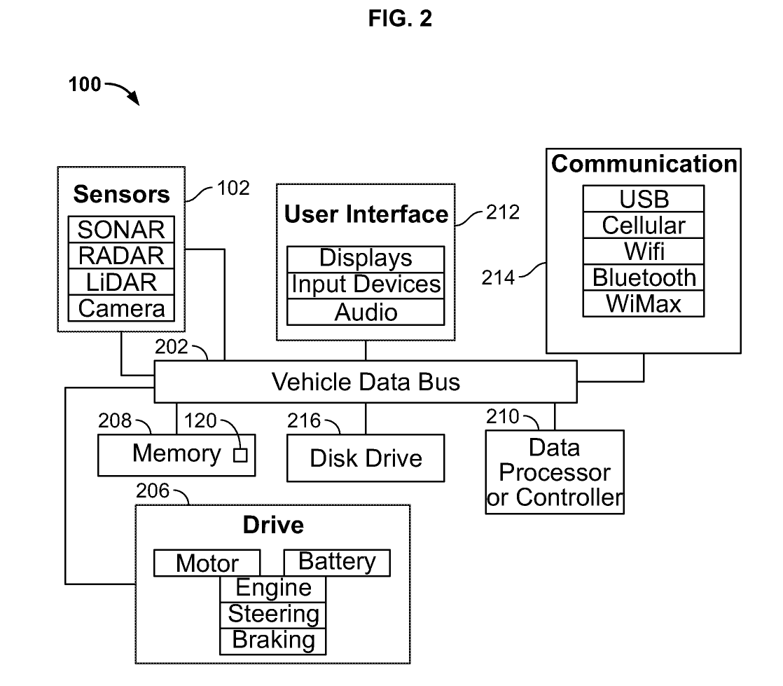

As shown in FIGS. 1A-1B and 2, vehicle 100 may include sensors 102, which may be arranged in and around the vehicle in a suitable fashion. Sensors 102 can all be the same or they can vary from one to the next. Sensors 102 may include many sensors or only a single sensor.

Certain of the sensors 102 may be configured to obtain data about the environment surrounding the vehicle (e.g., position sensors or weather sensors), as indicated by the dashed line in FIG. 1A, while others obtain data about components of the vehicle itself (e.g., gas level sensors or oil pressure sensors). The sensors 102 may be configured to transmit the data they obtain to one or more controllers of the vehicle 100, such as to controller 210 (described below), for further processing. The sensors 102 may include any suitable sensor or sensors such as, but not limited to: (1) infrared sensors; (2) visual sensors (such as cameras); (3) ultrasonic sensors; (4) RADAR; (5) LIDAR; (6) laser-scan sensors; (7) inertial sensors (for example, an inertial measurement unit); (8) wheel speed sensors; (9) road condition sensors (to directly measure certain road conditions); (10) rain sensors; (11) suspension height sensors; (12) steering wheel angle sensors; (13) steering torque sensors; (14) brake pressure sensors; (15) tire pressure sensors; or (16) vehicle location or navigation sensors (such as a Global Positioning System). Sensors 102 may include gear sensors configured to detect gear engagement of the vehicle's transmission, accelerometers configured to detect vehicle acceleration, speed sensors to detect vehicle speed, wheel speed, and/or steering wheel speed, torque sensors to detect engine or motor output torque, driveline torque, and/or wheel torque, and position sensors to detect steering wheel angular position, brake pedal position, and/or mirror position. Some sensors 102 may be mounted inside the passenger compartment of vehicle 100, around the exterior of the vehicle, or in the engine compartment of vehicle 100. At least one sensor 102 may be used to identify the vehicle's driver via facial recognition, speech recognition, or communication with a device, such as a vehicle key or mobile phone personal to the driver.

Sensors 102 may have an OFF state and various ON states. Vehicle 100, or a device operatively connected to the vehicle, may be configured to control the states or activity of the sensors. It should be appreciated that the term “internal sensors” includes all sensors mounted to the vehicle, including sensors that are mounted to an exterior of vehicle 100.

As shown in FIG. 2, in one embodiment, vehicle 100 includes a vehicle data bus 202 operatively coupled to sensors 102, vehicle drive devices 206, memory or data storage 208, a processor or controller 210, a user interface 212, communication devices 214, and a disk drive 216.

The processor or controller 210 may be any suitable processing device or set of processing devices such as, but not limited to: a microprocessor, a microcontroller-based platform, a suitable integrated circuit, or one or more application-specific integrated circuits (ASICs).

The memory 208 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.); unalterable memory (e.g., EPROMs); read-only memory; a hard drive; a solid state hard drive; or a physical disk such as a DVD. In an embodiment, the memory includes multiple kinds of memory, particularly volatile memory add non-volatile memory.

The communication devices 214 may include a wired or wireless network interface to enable communication with an external network. The external network may be a collection of one or more networks, including standards-based networks (e.g., 2G, 3G, 4G, Universal Mobile Telecommunications Autonomous valet parking system (UMTS), GSM® Association, Long Term Evolution (LTE)™, or more); WMAX; Bluetooth; near field communication (NFC); WFi (including 802.11 a/b/g/n/ac or others); WiMAX; Global Positioning System (GPS) networks; and others available at the time of the filing of this application or that may be developed in the future. Further, the external network(s) may be a public network, such as the Internet; a private network, such as an intranet; or combinations thereof, and may utilize a variety of networking protocols now available or later developed including, but not limited to, TCP/IP-based networking protocols. The communication devices 214 may also include a wired or wireless interface to enable direct communication with an electronic device, such as a USB or Bluetooth interface.

The user interface 212 may include any suitable input and output devices. The input devices enable a driver or a passenger of vehicle 100 to input modifications or updates to information shown in, for example, a vehicle display. The input devices may include, for instance, a control knob, an instrument panel, a keyboard, a scanner, a digital camera for image capture and/or visual command recognition, a touch screen, an audio input device (e.g., cabin microphone), buttons, a mouse, or a touchpad. The output devices may include instrument cluster outputs (e.g., dials, lighting devices), actuators, a display (e.g., a liquid crystal display (“LCD”), an organic light emitting diode (“OLED”), a flat panel display, a solid state display, a cathode ray tube (“CRT”), or a heads-up display), and speakers. It should be appreciated that the term pressing a button or feature also includes pressing or activating a virtual button or feature, such as using a mouse to click on an item on a display, or pressing a virtual button on a touch screen.

The disk drive 216 is configured to receive a computer readable medium. In certain embodiments, the disk drive 216 receives the computer-readable medium on which one or more sets of instructions, such as the software for operating system 400 described below. The instructions may embody one or more of the methods or logic as described herein. In a particular embodiment, the instructions may reside completely, or at least partially, within any one or more of the main memory 208, the computer readable medium, and/or within the processor 210 during execution of the instructions.

The term “computer-readable medium” should be understood to include a single medium or multiple media, such as a centralized or distributed database, and/or associated caches and servers that store one or more sets of instructions. The term “computer-readable medium” also includes any tangible medium that is capable of storing, encoding or carrying a set of instructions for execution by a processor or that cause a system to perform any one or more of the methods or operations disclosed herein.

In one embodiment, the vehicle 100 includes a one or more computer programs or subprograms stored in the memory 208. When executed by the processor, the one or more computer programs or subprograms generate or select instructions for other elements of the vehicle to perform. In various embodiments, the one or more computer programs or subprograms are configured to direct instructions to the user interface 212, the communication devices 214, the vehicle drive 206, the sensors 102, the processor 210, and any other component operatively connected to the vehicle data bus 202. It should be appreciated that vehicle 100 may be fully autonomous or partially autonomous.

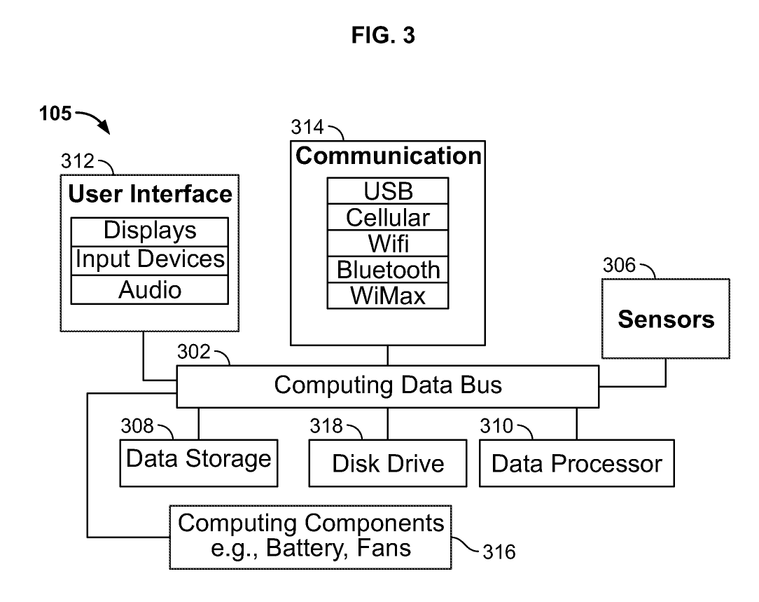

In various embodiments, a computing device 105 is operatively connected to the vehicle 100 via any suitable data connection such as WFi, Bluetooth, USB, or a cellular data connection. In one embodiment, shown in FIG. 3, the computing device 105 includes a data bus 302, operatively coupled to sensors 306, components 316, memory or data storage 308, a processor or controller 310, a user interface 312, and communication devices 314. It should be appreciated that the features of the computing device 105 may be similar to the features of the vehicle 100 as described above. For example, the communication devices 314 of the computing device 105 may operate similar to the communication devices 214 of the vehicle 100. The same applies to the user interface 312, the sensors 306, the data storage 308, the processor 310, and the disk drive 318. In various embodiments, the computing device 105 is a mobile phone or a server.

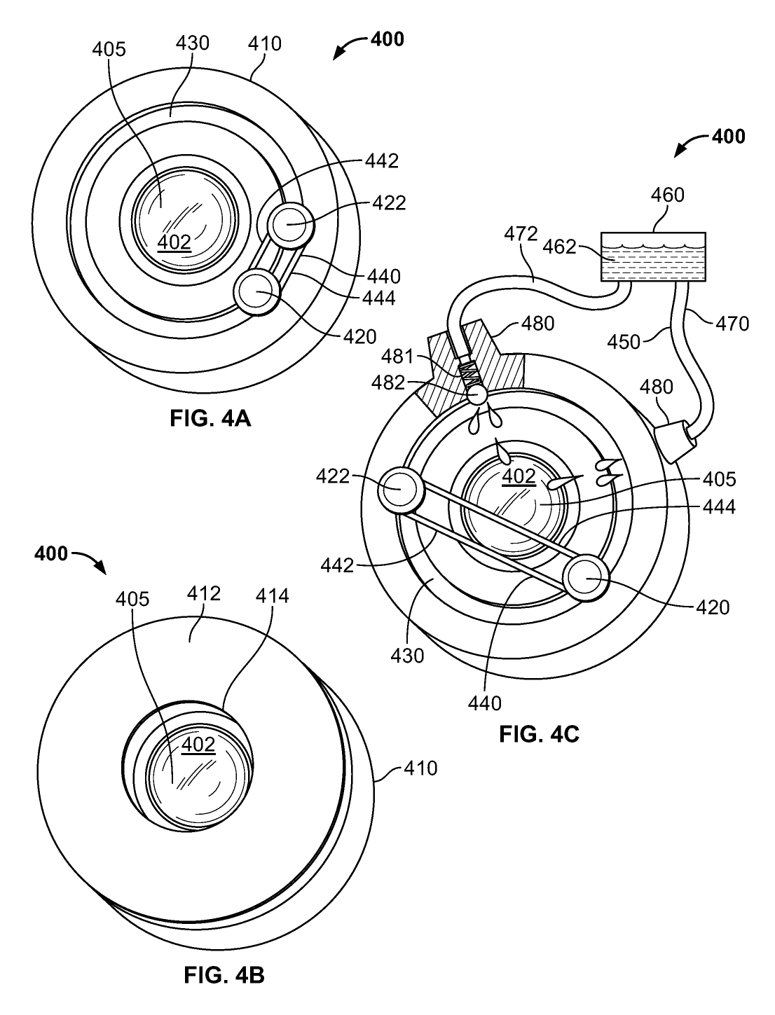

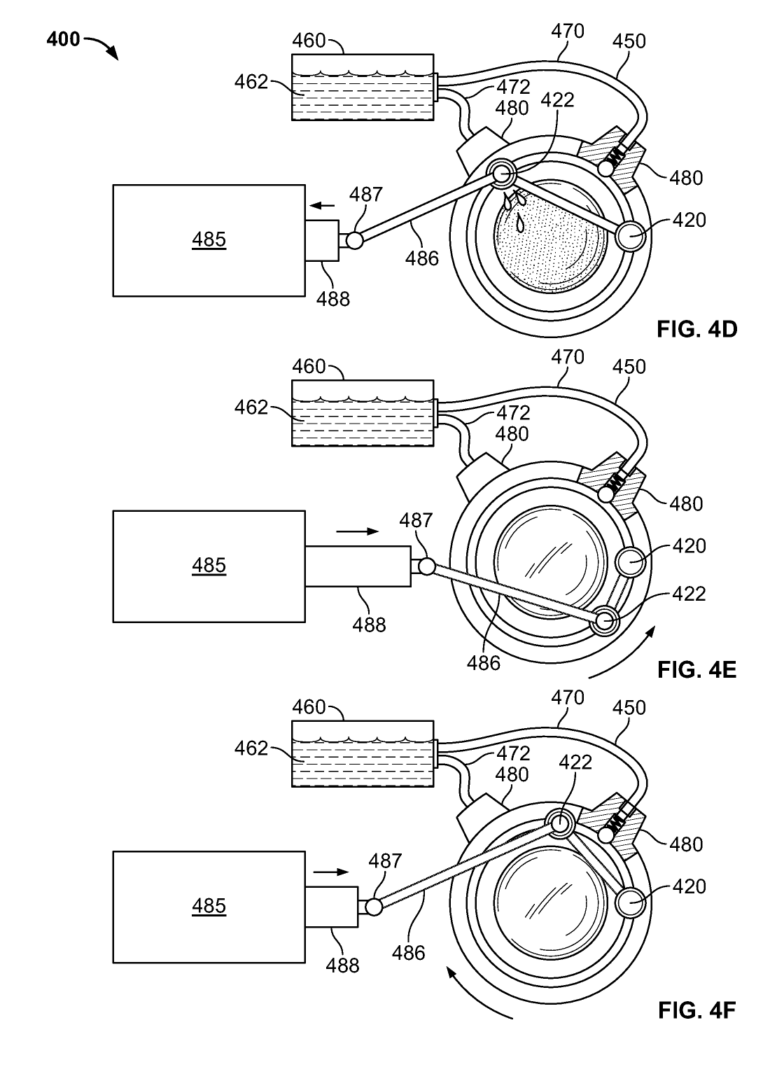

Turning to FIGS. 4A-4F, there is shown a camera washing system 400 to clean camera lens or cover 405 of a vehicle camera. In one embodiment, camera washing system 400 includes housing 410, housing cover 412, first wiper anchor 420, second wiper anchor 422, slot or track 430, and wiper 440. In some embodiments, camera washing system 400 also includes fluid delivery system 450 comprising washer fluid tank 460, washer fluid 462, first conduit 470, second conduit 472 and one or more valves 480.

Housing cover 412 includes an aperture 414, which permits an unobstructed view for the optics of camera 402 to capture the scene in the vicinity of vehicle 100. Housing cover 412 is configured to be detachably connected to housing 410 to easily remove and replace worn components of camera washing system 400.

Wiper 440 comprises an elastic material that extends from first wiper anchor 420 to second wiper anchor 422. In this embodiment, wiper 440 includes first wiper band 442 and second wiper band 444. Wiper 440 may comprise a rubber or any resilient material. First wiper anchor 420 is configured to lie in a fixed position in or near track 430. Second wiper anchor 422 is configured to be moveable along track 430 from a first, starting position to a second, ending position. As shown in the embodiments of FIGS. 4A and FIGS. 4C, track 430 can be circular in shape. As will be discussed in greater detail below, the movement of second wiper anchor 422 along track 430 causes wiper 440 to stretch across and swipe across camera lens 405 to push away dust, dirt, debris, snow, and water, etc. away from the surface of camera lens 405.

As shown in FIG. 4C, camera washing system 400 may include fluid delivery system 450, which may include first conduit 470 and second conduit 472, each connecting washer tank 460 to housing 410 via one or more valves 480. In the embodiment of FIG. 4C, a valve 480 is positioned at approximately the 10 o'clock position of housing 410 and another valve 480 is positioned at approximately the 2 o'clock position of housing 410. As shown in FIG. 4C, as second wiper anchor 422 traverses along track 430 in either a counterclockwise or clockwise motion, second wiper anchor 422 traverses past valve 480, which causes valve 480 to open and release fluid 462 from washer tank 460. Fluid 462 may enhance the cleaning of camera lens 405 as wiper 440 sweeps across camera lens 405.

The one or more valves may be positioned at any position depending on the orientation of housing 410 to gravity. For example, with valves 480 positioned at the 10 o'clock position and the 2 o'clock position, fluid 462 from washer tank 460 may be conveyed via gravity to valves 480 via first conduit 470 and second conduit 472 and thereafter dispensed onto camera lens 405. Fluid 462 dispensed from valves 480 may flow across camera lens 405 due to gravity and also be wiped across camera lens 405 due to movement of wiper 440 across camera lens 405. The one or move valves 480 may include biasing spring 481 and valve closure member 482. Spring 481 may bias valve closure member 482 in the valve closed position until second wiper anchor 422 is commanded to traverse past closure member 482, which motion deflects valve closure member 482 into the valve open position to release fluid 462 from fluid delivery system 450. In other embodiments, the one or more valves 480 may be any mechanical or electro-mechanical valve including a solenoid-controlled valve or proportioning valve. In some embodiments, a controller having a timer may time the opening of the one or more valves 480 and the valve 480 may be electrically opened and closed.

Turning to FIGS. 4D-4F, there is shown one method of moving second wiper anchor 422 along track 430. As shown, camera washing system 400 may include motor 485 and rod 486. Motor 485 may be configured as a reciprocating motor. Rod 486 may be configured as a rod, an I-beam, or any other geometry to communicate motion from motor 485 to second wiper anchor 422. Rod 486 may be pivotally connected to pivot 487 on one end, and pivotally connected to second wiper anchor 422 on the other end. Pivot 487 may be connected to output shaft 488 of motor 485. When motor 485 is commanded to activate, output shaft 488 may translate fore and aft thereby moving rod 486. With second wiper anchor 422 being constrained to move along track 430 while being connected to rod 486, as output shaft 488 is pulled aft by motor 485, second wiper anchor 422 is caused to traverse counter-clockwise along track 430 from the first, starting position (best shown in FIG. 4A) to the second, ending position (best shown in FIG. 4E).

Motor 485 may be commanded to operate continuously, which forces second wiper anchor 422 clockwise along track 430 until the first, starting position is reached, and then back again in a counter-clockwise direction to the second, ending position. In this way, multiple passes of wiper 440 may be made across camera lens 405 in a single command cycle of motor 485. In addition, as discussed above, as second wiper anchor 422 passes each valve 480 in sequence, washer fluid 462 is dispensed, which may be wiped across camera lens 405 by wiper 440.

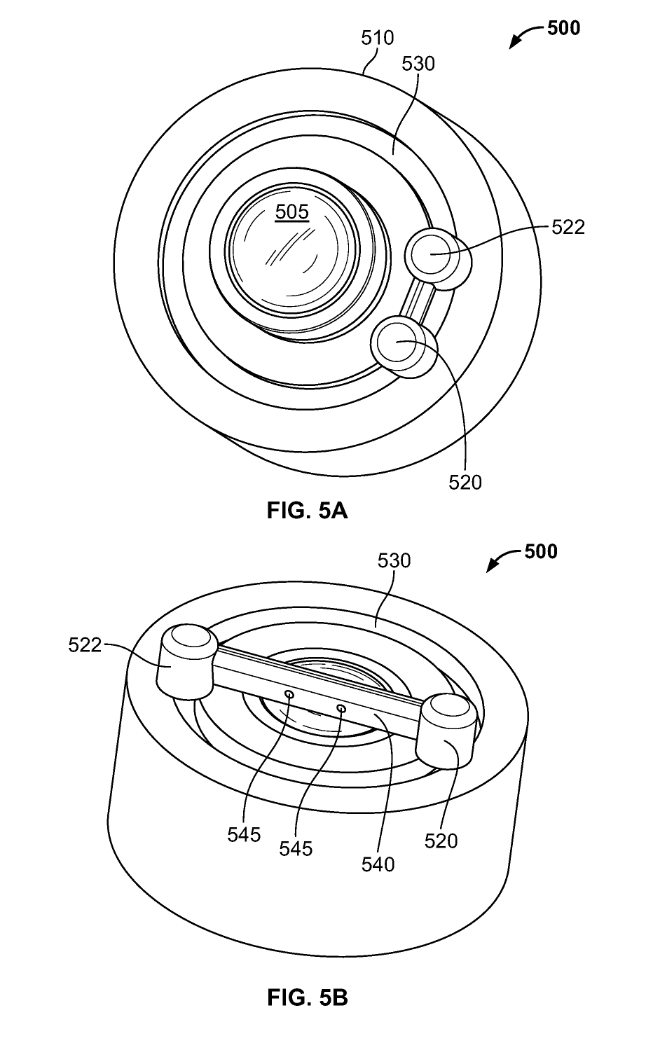

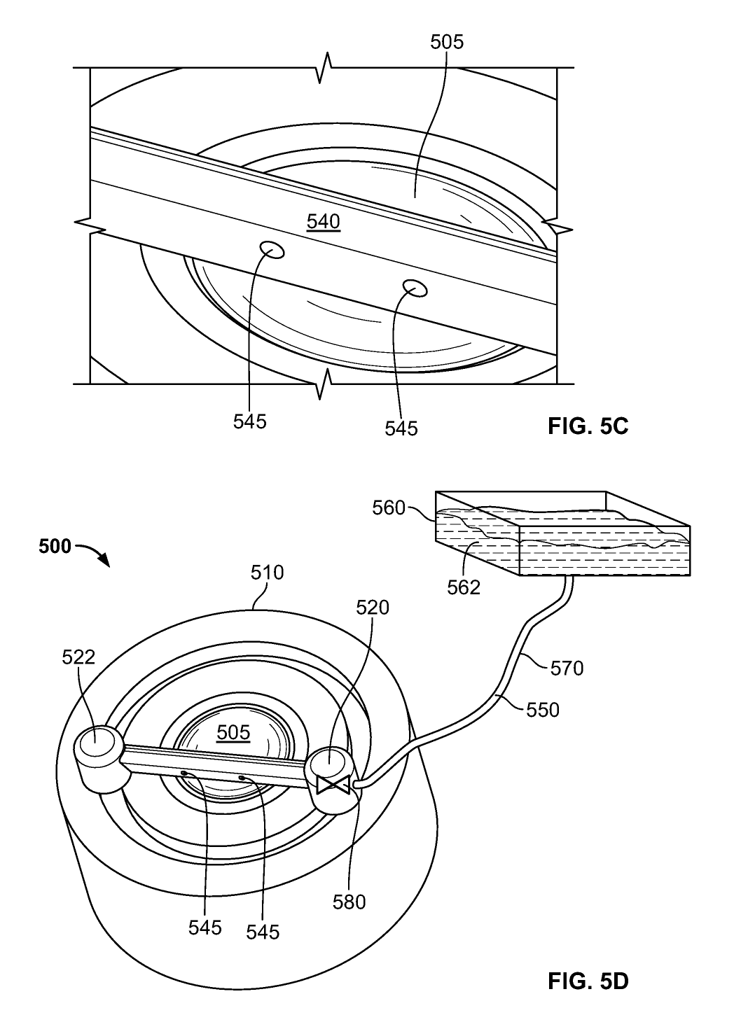

Another embodiment of a camera washing system is shown in FIGS. 5A-5D. In this embodiment, camera washing system 500 includes all of the same features and operates in the same way as camera washing system 400 except that the wiper and washer fluid delivery system is different. Specifically, camera washing system 500 includes housing 510, housing cover 512 (not shown), first wiper anchor 520, second wiper anchor 522, slot or track 530, and wiper 540. Camera washing system 500 also includes fluid delivery system 550 comprising washer fluid tank 560, washer fluid 562, conduit 570, and one or more valves 580.

Wiper 540 comprises a tubular structure that extends from first wiper anchor 520 to second wiper anchor 522. First wiper anchor 520 is configured to lie in a fixed position in or near track 530. Second wiper anchor 522 is configured to be moveable along track 530 from a first, starting position to a second, ending position. Track 530 can be circular in shape. Similar to camera washing system 400, movement of second wiper anchor 522 along track 530 causes wiper 540 to stretch and/or telescope across and swipe across camera lens 505 to push away dust, dirt, debris, snow, and water, etc. away from the surface of camera lens 505.

As shown in FIG. 5D, camera washing system 500 may include fluid delivery system 550, which may include conduit 570 connecting washer tank 560 to housing 510 via valve 580 positioned in first wiper anchor 520. In this embodiment, wiper 540 includes one or more fluid orifices 545 where wiper 540 acts as a conduit for fluid 562.

In this embodiment, fluid 562 from washer tank 560 may be conveyed via gravity via conduit 570 to first wiper anchor 520 having valve 580. When valve 580 opens, fluid 562 is conveyed inside the conduit formed by wiper 540 to the one or more fluid orifices 545 and thereafter dispensed onto camera lens 505. Fluid 462 dispensed from valves 480 may flow across camera lens 405 due to gravity and also be wiped across camera lens 405 due to movement of wiper 440 across camera lens 405.

Valve 580 may be any mechanical or electro-mechanical valve including a solenoid-controlled valve or proportioning valve. In some embodiments, a controller having a timer may time the opening of valve 580 and valve 580 may be electrically opened and closed to allow fluid 562 to be dispensed.

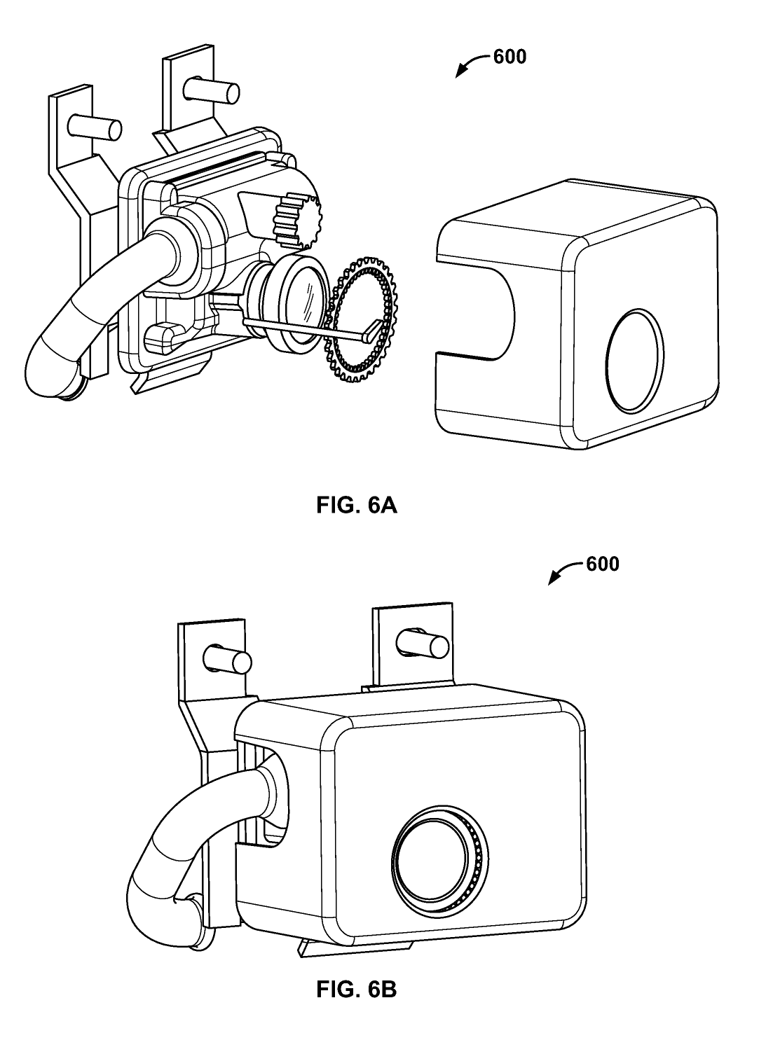

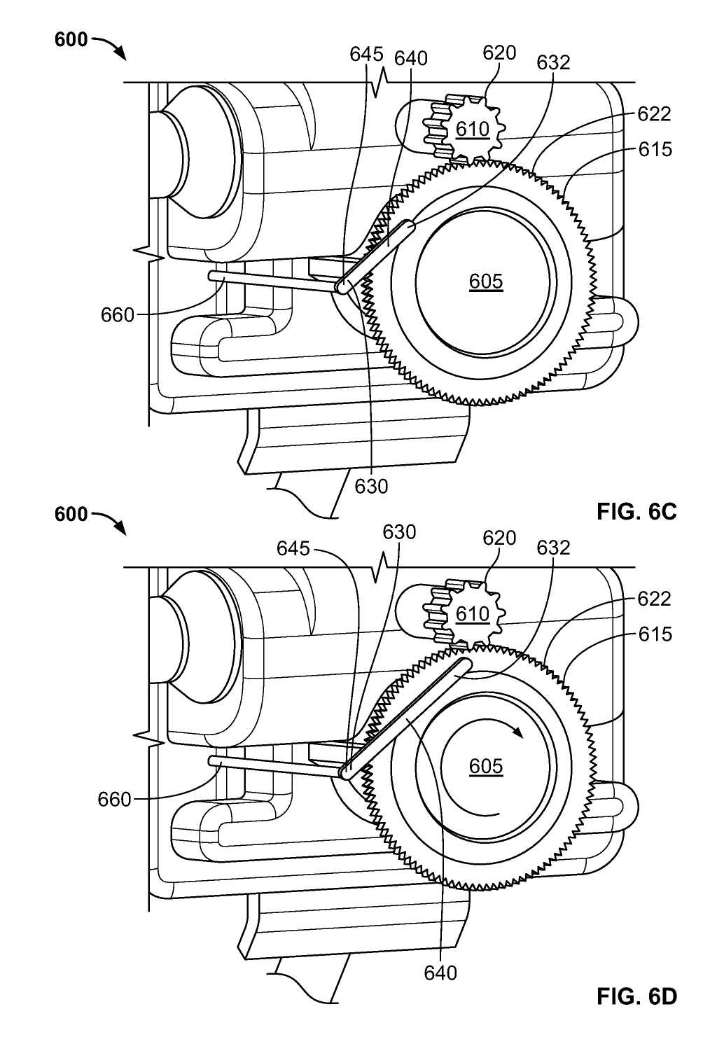

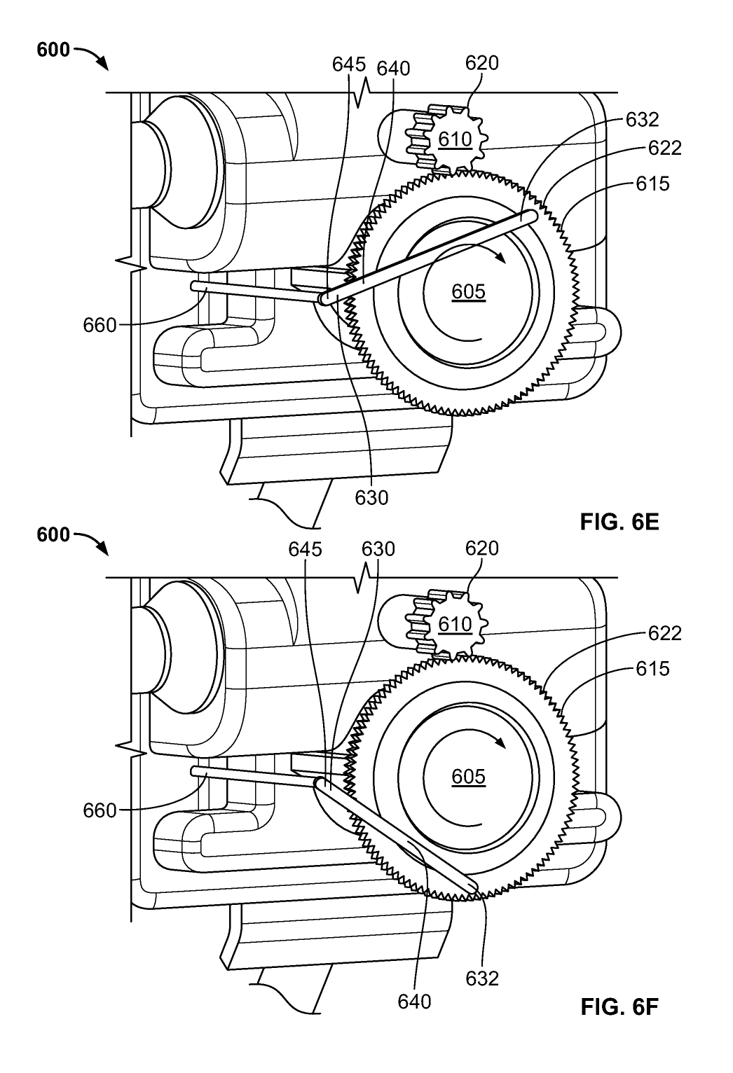

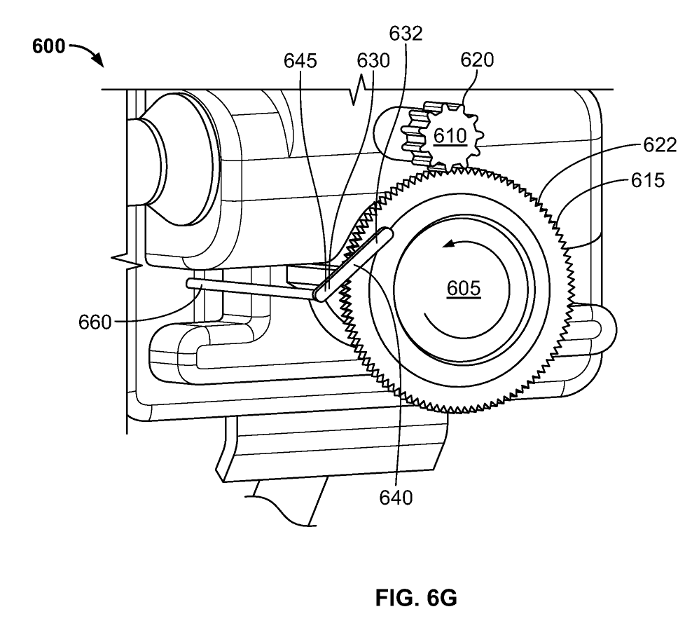

Another embodiment of a camera washing system for retrofitting an existing vehicle camera system is shown in FIGS. 6A-6G. In this embodiment, camera washing system 600 includes driver gear 610, gear 615, wiper 640, and wiper mount 660. Driver gear 610 is connected to gear 615 via gear teeth 620,622. In one embodiment, wiper 640 comprises an elastic material. Wiper 440 may comprise a rubber or any resilient material. In another embodiment, wiper 640 is configured to extend from a first position to a second position.

One end 630 of wiper 640 is attached to pivot 645 and the other end 632 of wiper 640 is attached along a perimeter of gear 615. Driver gear 610 is connected to a motor (not shown). As the driver gear 610 is commanded to rotate via the motor, gear 615 turns correspondingly. End 632 of wiper 640 follows the rotation of gear 615 as gear 615 rotates in either a clockwise or counter-clockwise direction depending on the direction of rotation of driver gear 610. In one embodiment, wiper 640 extends from a first length when end 632 is at a first, starting position (see, e.g., FIG. 6C) to a second length when end 632 is positioned opposite pivot 645 on the other side of gear 615. The motor may continue to turn until wiper 640 reaches the end of its stroke, as shown in FIG. 6F, at which point the motor may be commanded to reverse and cause gear 615 to rotate in the counter-clockwise direction to return to the stroke starting position, as shown in FIG. 6F. In other embodiments, gear 615 may be caused to make 360 degree revolutions.

While specific embodiments have been described in detail, it will be appreciated by those skilled in the art that various modifications and alternatives to those details could be developed in light of the overall teachings of the disclosure. Accordingly, the disclosure herein is meant to be illustrative only and not limiting as to its scope and should be given the full breadth of the appended claims and any equivalents thereof.

What is claimed is:

1. A vehicle camera washing system, comprising:
a housing configured for supporting a vehicle camera;
a housing cover having an aperture for a lens of the vehicle camera, the housing cover removably positioned on a face of the housing;
a circular groove positioned in the face of the housing;
a first wiper anchor fixedly positioned in the groove;
a second wiper anchor movably positioned in the groove; and
an elastic wiper extending from the first wiper anchor to the second wiper anchor.

2. The system of claim 1, comprising a motor connected to the second wiper anchor, the motor configured to move the second wiper anchor along the groove from a first position to a second position.

3. The system of claim 2, wherein movement of the second wiper anchor to the second position stretches the wiping elements across the camera lens.

4. The system of claim 2, wherein the first position is at a 3 o'clock position on the face of the housing, and wherein the second position is at a 6 o'clock position on the face of the housing.

5. The system of claim 2, wherein the motor moves the second wiper anchor in a counter-clockwise direction in the groove until the second position is reached, and then moves the second wiper anchor in a clockwise direction in the groove until the first position is reached, the wiper thereby being swept across the lens of the camera.

6. The system of claim 1, comprising a fluid delivery system comprising a valve positioned on a periphery of the housing, the valve connected to a fluid tank by a conduit configured to convey a fluid from the fluid tank to the valve.

7. The system of claim 6, wherein the valve is actuated to release the fluid onto the lens of the camera by movement of the second wiper anchor past the valve.

8. The system of claim 7, wherein the valve is radially positioned at a 2 o'clock position on the housing and a second valve is radially positioned at a 10 o'clock position on the housing.

9. The system of claim 7, wherein the wiper comprises a plurality of wiping elements configured to sweep across the lens of the camera.

10. A vehicle camera washing system for a vehicle camera lens cover, comprising:
a washer housing;
a circular slot positioned in a face of the housing;
a first wiper anchor fixedly positioned on the face of the housing;
a second wiper anchor movably positioned in the slot; and
a variable extension wiper extending from the first wiper anchor to the second wiper anchor, the wiper comprising a wiping element configured to sweep across the vehicle camera lens cover.

11. The system of claim 10, comprising a reciprocating motor connected to the second wiper anchor, the motor configured to move the second wiper anchor along the slot from a first position to a second position.

12. The system of claim 11, wherein movement of the second wiper anchor to the second position variably extends the wiping element across the vehicle camera lens cover.

13. The system of claim 11, wherein the reciprocating motor moves the second wiper anchor in a counter-clockwise direction in the slot until the second position is reached, and then moves the second wiper anchor in a clockwise direction in the slot until the first position is reached, the wiper thereby being swept across the camera lens cover.

14. The system of claim 11, comprising a rod pivotally connected on one end to an output shaft of the reciprocating motor and pivotally connected on an opposite end to the second wiper anchor.

15. The system of claim 11, wherein the first wiper anchor includes a valve connected to a fluid tank by a conduit configured to convey a fluid from the fluid tank to the valve, the valve configured to dispense the fluid onto the vehicle camera lens cover.

16. The system of claim 15, wherein the wiper comprises at least one orifice positioned between the first wiper anchor and the second wiper anchor along the wiper, the at least one orifice connected to the valve for dispensing the fluid onto the vehicle camera lens cover.

17. A vehicle camera washing system for a vehicle camera lens cover, comprising:
a driver gear;
a first gear positioned adjacent to and driven by the driver gear, the first gear comprising a ring positioned around the lens cover;
a wiper mount positioned adjacent to the first gear;
an elastic wiper pivotally attached to the wiper mount on one end and pivotally attached to a perimeter face of the first gear on an opposite end, the wiper configured to elastically extend and sweep across the lens cover upon rotational movement of the first gear by the driver gear.

18. The system of claim 17, comprising a motor connected to the driver gear, the motor configured to rotate the driver gear.

19. The system of claim 18, wherein the opposite end of the wiper follows rotation of the first gear as the driver gear rotates in either a clockwise or counter-clockwise direction.

20. The system of claim 17, including a controller comprising a processor, the controller coupled to the motor and configured to command rotation of the driver gear through a plurality of rotational angles and rotation cycles.
